(19) United States
(12) Patent Application Publication
(10) Pub. No.: US 2007/0146718 A1
(43) Pub. Date: Jun. 28, 2007

(54) OPTICAL INSPECTION METHOD AND OPTICAL INSPECTION APPARATUS USED FOR THE SAME

(75) Inventors: Tomohiro TAKASE, Kanagawa (JP); Ikuo Uematsu, Kanagawa (JP); Isao Nawata, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/565,897

(22) Filed: Dec. 1, 2006

(30) Foreign Application Priority Data
Dec. 22, 2005 (JP) 2005-370298

(51) Int. Cl. G01N 21/55

(52) U.S. Cl. 356/445

(57) ABSTRACT

An inspection method using a portable optical inspection apparatus adapted to be driven by a battery and capable of producing an accurate sensing result without being adversely affected by the environmental temperature conditions is disclosed. The light is radiated on a sensor chip for a predetermined length of time and the amount of a substance contained in a specimen placed on a sensing thin film is measured by an optical signal obtained from the sensing chip, using an optical inspection apparatus comprising the sensor chip including a substrate 5, an optical waveguide layer 6 arranged on the substrate and the sensing thin film 7 attached on the surface of the optical waveguide layer, a light source 8 for radiating the light on the sensor chip and a photodetector 9 for receiving and converting the light output from the sensor chip into an electrical signal The light source is turned on and off a plurality of times for a predetermined length of time during which the inspection light is radiated. The amount of light with the light source on is measured by the photodetector thereby to determine the amount of the substance. In the process, the light amount with the light source off can also be measured so that the amount of the substance is determined from the difference between the light amount with the light source on and off.

### BACKGROUND OF THE INVENTION

1. Field of the Invention

The present invention relates to an optical inspection technique for measuring the amount of a substance in a specimen, and in particular to an optical inspection method and a portable optical inspection apparatus having an optical waveguide sensor.

2. Related Art

Vigorous research and development efforts are now going on for practical applications of medical sensors such as an immunological sensor, and the optical waveguide sensor is closely watched as a medical sensor. The optical waveguide sensor is configured of a tabular translucent substrate constituting an optical waveguide layer and a thin film having the sensing function coupled to the surface of the translucent substrate. An organic tissue or an organic tissue fluid attached or placed on the surface of the sensing thin film chemically or physically interacts with the thin film material, and the resulting change in physical characteristics caused in the sensing thin film is detected by the inspection light propagated while being totally reflected in the optical waveguide layer. The conventionally known optical waveguide sensors include (1) a sensor taking advantage of the phenomenon in which when the inspection light is propagated while being totally reflected in the optical waveguide layer, the evanescent wave generated in the boundary between the optical waveguide layer and the sensing thin film is absorbed into the sensing thin film or the substance existing on the surface thereof and the inspection light is attenuated (see Japanese Patent Application, Publication No. 2004-184381, and (2) a sensor in which the evanescent wave generated by the inspection light excites the substance existing on the surface of the sensing thin film and the amount of the fluorescent light generated thereby is measured (see Japanese Patent Application, Publication No. HEI8-285851).

In the former, the transmittance of the inspection light is observed and the amount of a specific substance existing in the organic tissue or the organic tissue fluid is determined from the attenuation rate, while in the latter, the amount of a specific substance is determined from the amount of the fluorescent light generated.

The inspection using the optical waveguide sensor described above is not limited to the quantification of a substance existing in an organic tissue or an organic tissue fluid, and efforts are also being made variously. For example, an organic tissue is brought into contact with a glass chip and light is radiated continuously in an attempt to detect the reaction rate of a substance contained in an organic tissue from the secular variation of the intensity of the measurement light.

In the optical inspection apparatus for medical applications described above, the measurement performance of the apparatus is often limited by the operating environment such as temperature and illuminance. The portable inspection device used by general consumers, on the other hand, unlike the stationary inspection apparatus operated by a specialist versed in the device operation, is expected to be used under various different conditions. Thus, an easy-to-handle portable inspection device which can secure the inspection accuracy in any operating conditions is in demand. In the optical inspection apparatuses described above, for example, the quality of the beam (beam pattern, beam spread, polarization, wavelength, coherence, etc.) output from a light source is varied depending on the environmental temperature. This indicates that the light propagation, reflectivity/transmittance and light interference in the glass sensor chip used with the inspection apparatus are affected, and the light intensity measured is changed by the effects of the environment. In such a situation, the correct measurement result cannot be expected, and without overcoming this problem, the practical application of a commercially available optical inspection apparatus for medical use is difficult.

The most effective technique to cope with the aforementioned problem may be to control the light source temperature using a heater or a Pettier element. This technique, though very promising for the stationary optical inspection apparatuses, encounters many problems for application to portable optical inspection apparatuses. For example, these control devices (1) are bulky, (2) consume so large power that the battery used for the inspection apparatuses is short lived, and (3) inconveniently require the waiting time for temperature control before measurement and therefore cannot be used readily.

As described above, in the optical inspection apparatus for medical application in which the sensing result is determined by use of a tabular glass chip having the sensing function and an optical signal obtained by radiating the light on the tabular glass chip, the measurement result is easily affected by the environmental temperature. In order to obtain the correct sensing result, it 4s effective to control the temperature of the light source. The problem, however, is that this method is not easily applicable to a portable optical inspection apparatus.

### BRIEF SUMMARY OF THE INVENTION

The object of the present invention is to realize a portable optical inspection apparatus capable of being driven by a battery and producing an accurate sensing result without being affected by the environmental conditions such as temperature.

An optical inspection method according to an embodiment of the present invention using an optical inspection apparatus comprising a sensor chip including a substrate, an optical waveguide layer arranged on the substrate and a sensing thin film attached on the surface of the optical waveguide layer, a light source for radiating the light on the sensor chip and a photodetector for receiving and converting the light output from the sensor chip into an electrical signal, comprising:

radiating the light on the sensor chip by turning on and off the light source a plurality of time,

receiving and converting the light output from the sensor chip into an electrical signal, and

determining the amount of a substance contained in a specimen placed on the sensing thin film by the electrical signal converted by the photodetector.

In the first embodiment of the present invention, the amount of a substance is preferably measured from the difference in the light amount measured by the photodetector between the turn-on time period and the turn-off time period of the light source. Also, in the first embodiment of the present invention, the light source is preferably either a semiconductor laser device (LD) or an optical semiconductor device (LED).

An optical inspection apparatus according to a second embodiment of the present invention comprises a sensor chip including a substrate, an optical waveguide layer arranged on the substrate and a sensing thin film attached on the surface of the optical waveguide layer, a light source for radiating the light on the sensor chip and a photodetector for receiving and converting the light output from the sensor chip into an electrical signal,

wherein the light is radiated on the sensor chip for a predetermined length of time and the amount of a substance contained in a specimen placed on the sensing thin film is measured by the optical signal obtained from the sensor chip, and

wherein a diffusion sheet having the haze, as converted into a light diffusion index, of 10.0% or more is arranged on the light path from the light source to the sensor chip.

An optical inspection apparatus according to a third embodiment of the present invention comprises a light source for radiating the light on a sensor chip including a substrate, an optical waveguide layer arranged on the substrate and a sensing thin film attached on the surface of the optical waveguide layer and a photodetector for receiving and converting the light output from the sensor chip into an electrical signal,

wherein the light is radiated on the sensor chip for a predetermined length of time and the amount of a substance contained in a specimen placed on the sensing thin film is measured by the optical signal obtained from the sensor chip, and

the optical inspection apparatus further comprising a housing for accommodating the light source and the photodetector, the light source being fixed on the housing through a member of a material having the heat conductivity of 1.0 W/mK or less.

An optical inspection apparatus according to a fourth embodiment of the present invention comprises a housing on which a sensor chip including a substrate, an optical waveguide layer arranged on the substrate and a sensing thin film attached on the surface of the optical waveguide layer is mounted, a light source accommodated in the housing for radiating the light on the sensor chip and a photodetector arranged in the housing for receiving and converting the light output from the sensor chip into an electrical signal,

wherein the light is radiated on the sensor chip for a predetermined length of time and the amount of a substance contained in a specimen placed on the sensing thin film is measured by the optical signal obtained from the sensor chip,

wherein the light source is fixed on the housing through a member of a material having the heat conductivity of 1.0 W/mK or less,

wherein a diffusion sheet having the haze, as converted into a light diffusion index, of 10.0% or more is arranged on the light path from the light source to the sensor chip, and

wherein the light source is turned on and off for a predetermined length of time during which the light is radiated to measure the amount of a substance in the specimen arranged on the surface of the sensing thin film.

As described above, according to the present invention, there is provided a portable optical inspection apparatus, in which the light is radiated on a tabular glass chip and the sensing result is determined from an optical signal thus obtained and which is less affected by the environmental temperature.

### BRIEF DESCRIPTION OF THE DRAWINGS

FIG. 1 is a sectional view schematically showing an optical inspection apparatus according to a first embodiment;

FIG. 2 is a timing chart for measurement in an optical inspection method according to the first embodiment;

FIG. 3 is a sectional view schematically showing an optical inspection apparatus according to a second embodiment;

FIG. 4 is a sectional view schematically showing an optical inspection apparatus according to a third embodiment;

FIG. 5 is a view schematically showing an optical inspection apparatus according to another embodiment; and

FIG. 6 is a timing chart for measurement in the conventional optical inspection method.

### DETAILED DESCRIPTION OF THE INVENTION

### First Embodiment

Light from, for example, a laser diode used in the present embodiment has a very high coherency. The wavelength shift and the spectral distribution of the light having a high coherency are liable to change with temperature. The use of the light sensitive to temperature changes reduces the reliability of the measurement result due to a temperature change which may occur during measurement. In an optical inspection apparatus according to the present embodiment, the reduction in accuracy of the inspection result due to a temperature rise is avoided by suppressing the temperature rise of the light source providing a heat source for the sensor chip.

(Inspection Apparatus)

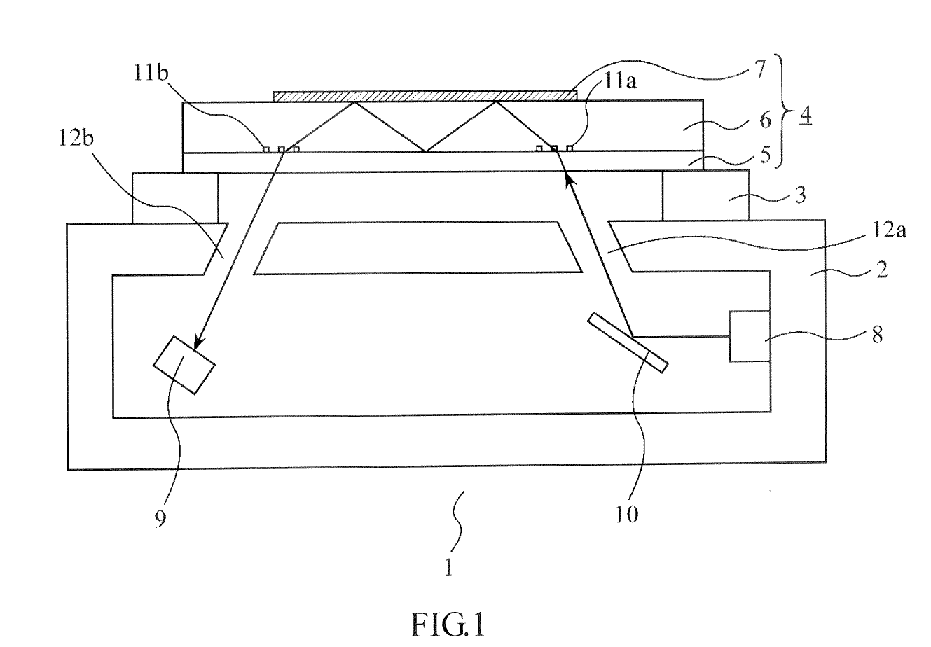

An optical inspection apparatus according to the present embodiment is explained with reference to the schematic diagram of FIG. 1.

In FIG. 1, reference numeral 1 designates an optical inspection apparatus. This optical inspection apparatus mainly comprises a housing 2 formed of a material such as a metal high in heat conductivity and strength, a sensor chip 4 arranged as an attachment to the housing 2, a light source 8 such as a semiconductor laser device (LD) or an optical semiconductor element (LED) arranged in the housing 2, an optical system 10 such as a reflector for radiating the light from the light source 8 on the sensor chip 4, and a photodetector 9 such as a photodiode for receiving the light output from the sensor chip.

In the optical inspection apparatus according to the present embodiment, though not shown in FIG. 1, the light source 8 and the photodetector 9 are connected to a control unit for controlling the on/off timing of the light source 8 or processing the light amount information of the inspection light output from the photodetector 9 to calculate the amount of a substance contained in a specimen.

These component elements are preferably driven by power supplied from a battery not shown.

The sensor chip 4 includes a transparent substrate 5 of such a material as borosilicate glass, an optical waveguide layer 6 formed on the surface of the transparent substrate 5, and a sensing thin film 7 formed on the surface of the optical waveguide layer 6. A specimen containing a substance to be inspected, not shown, is placed on the surface of the sensing thin film 7. The surface of the optical waveguide layer 6 nearer to the sensing thin film 7 is formed with gratings 11a, 11b for optical coupling.

Holes 12a, 12b for passing the inspection light are formed in the housing 2. The inspection light is radiated on the optical waveguide layer 6 from the light source 8 through the optical system 10, the hole 12a and the transparent substrate 5. The inspection light is introduced into the optical waveguide layer 6 by the first grating 11 formed on the surface of the optical waveguide layer and, while being totally reflected in the optical waveguide layer 6, propagates through the optical waveguide layer 6 and is radiated from the second grating lib so that the photodetector 9 arranged in the housing 2 through the hole 12b measures the light amount of the inspection light.

The optical and other physical characteristics of the inspection light propagating through the optical waveguide layer 6 undergo a change, in the boundary between the optical waveguide layer 6 and the sensing thin film 7, in accordance with the amount of a specific substance existing in the specimen, which in turn attenuates the intensity of the inspection light. By measuring this attenuation amount with the photodetector 9, the amount of the specific substance is measured.

Various light emitting elements can be used as the light source. Especially, the laser diode is preferable for its small size and weight, the capability of drive with a low voltage and a large optical output. As described above, this light source can be turned on/off by the control unit.

The optical waveguide layer may be formed of glass, SiO₂ or transparent ceramics such as silicon nitride film or a transparent material such as an organic polymer resin.

The sensing thin film is usable, of which the physical characteristics are changed by the amount of a substance existing in the specimen and which is capable of detecting the change in the physical characteristics by the radiation of the inspection light. Specific examples of the sensing thin film having the sensor function utilizing the antigen-antibody reaction include the antibody-fixed film with a fixed antibody included in the specimen solution and reacting with a light source, a chemical reactive with sugars such as glucose or other substances contained in the specimen, an organic polymer compound film with oxygen or a coloring agent added thereto or a metal thin film for detecting the change in dielectric constant of the material existing on the surface by the surface plasmon resonance.

The grating formed on the optical waveguide layer is a member for realizing the optical coupling function to introduce the light from the light source into the optical waveguide layer. By forming the grating on the surface of the optical waveguide layer located in the boundary between the surface of the optical waveguide layer and the transparent substrate, the inspection light can be propagated through the optical waveguide layer without any loss. This grating can be formed of a thin film of such a material as titanium oxide, tin oxide, zinc oxide, lithium niobate, gallium arsenide, indium-tin oxide or polyimide.

Any other optical members such as a prism capable of exhibiting the optical coupling function can be used in place of the grating.

(Inspection Steps)

The inspection steps for measuring the amount of a substance in the specimen using the inspection apparatus shown in FIG. 1 are explained below.

The inspection method according to the present embodiment is intended to improve the inspection accuracy by turning on/off the inspection light source and thus suppressing the temperature rise of the light source using the optical inspection apparatus described above. Also, this inspection method is intended to secure the accuracy of the measurement result by measuring the amount of the inspection light using the photodetector with the light source turned on and off and determining the amount of a specific substance from the difference light amount.

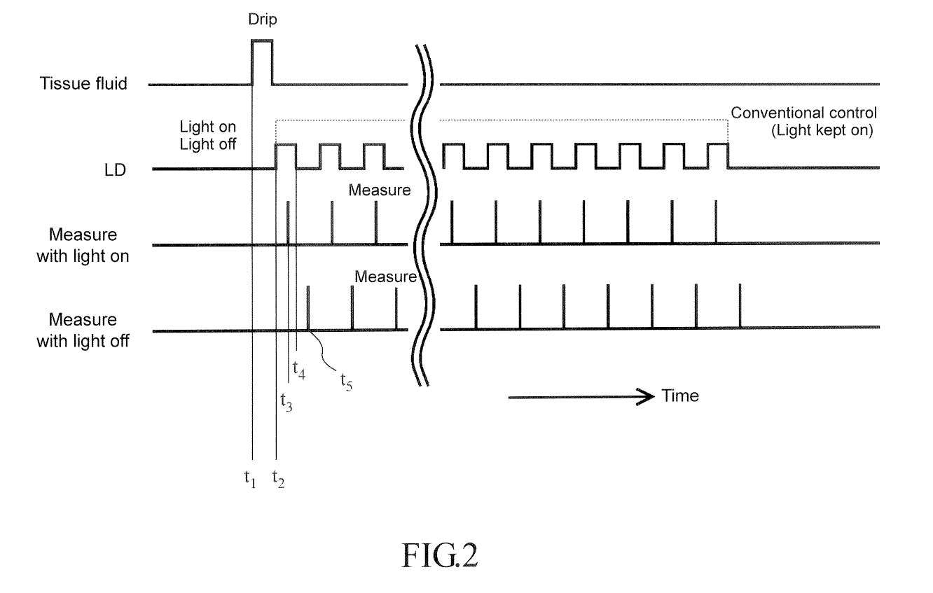

FIG. 2 is a timing chart showing steps of the inspection method according to the present embodiment. In FIG. 2, the abscissa represents the time elapsed. At time point t1, an organic tissue fluid constituting a specimen is applied and coated on the surface of the sensing thin film. Then, at time point t2, the light source 8 is turned on. After that, at time point t3, the amount of the inspection light with the light source 8 on is measured by the photodetector 9. At time point t4, the light source is turned off, followed by time point t5 at which the amount of the inspection light with the light source off is measured by the photodetector 9. The cycle of t2 to t5 is repeated a predetermined number of times to measure the amount of the inspection light. The difference between the amount of the inspection light with the light source on and the amount of the inspection light with the light source off, which are obtained from the aforementioned steps, is calculated. The difference between the amount of the inspection light radiated from the light source and the aforementioned light amount difference is the attenuation of the inspection light and proportional to the density of the substance existing in the organic tissue or the organic tissue fluid on the sensing thin film. Thus, the density of a specific substance can be determined by preparing a calibration curve of attenuation measurement for a specimen having a known substance density and referring to the calibration curve.

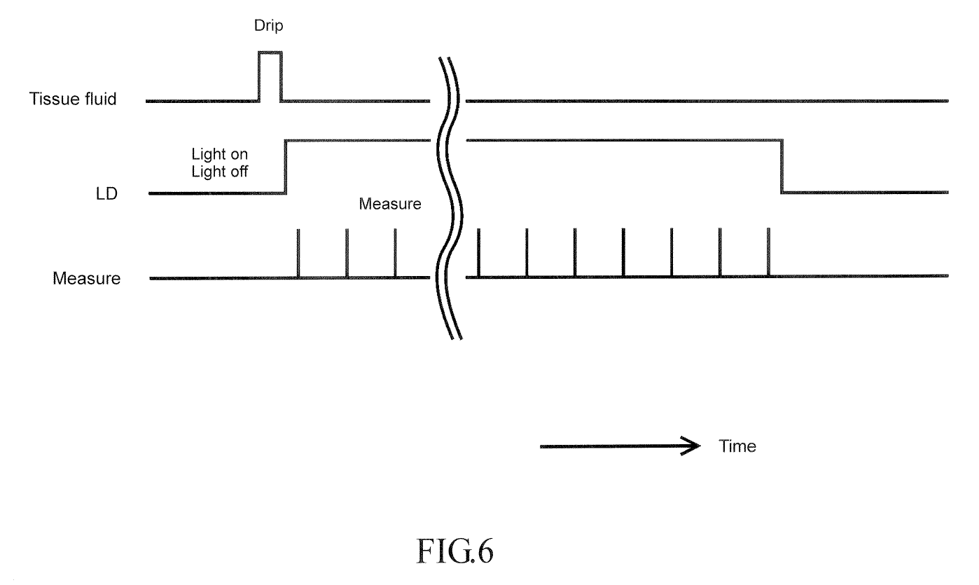

Specifically, in the timing chart described above, the turn-on time and the turn-off time of the light source and the number of turn on/off sessions can be arbitrarily selected in accordance with the reaction time of a substance to be measured. For example, the laser diode of the light source is turned on for 0.5 seconds and turned off for 0.5 seconds, and by repeating this step, the light amount is measured for 60 seconds. In the process, the amount of heat generation can be further reduced preferably by reducing the light amount with the light source on as compared with the light amount of the light-emitting device normally used. As shown in FIG. 6, as compared with the conventional method using the measurement timing chart in which the light source is kept on, the amount of heat generation from the LD can be reduced to about one fourth by turning on/off the light source under the conditions described above and further controlling the light amount to one half for the normal operation. As a result, the beam quality variation of the light source is reduced for improved measurement accuracy.

With the reduction in light amount from the laser diode according to the aforementioned method, the signal level of the intensity of the inspection light from the light source is reduced and the difference with the signal level of the noise caused by the stray light intruding from outside of the optical inspection apparatus is reduced for a lower measurement accuracy. By determining the difference of the measurement light intensity between the turn-on and turn-off states of the laser diode and calculating the net signal intensity and the net attenuation amount, however, the reduction in measurement accuracy can be avoided.

According to the embodiment described above, the amount of heat radiated from the light source and the characteristics change of the light radiated from the light source due to the heat can be reduced by turning on/off the light source.

Also, with the portable inspection apparatus, the amount of heat generated from the light source is desirably reduced and for this purpose, the optical output is required to be limited. In the case where the inspection light of small output is used, however, the intensity of the stray light entering the inspection apparatus from outside is increased as compared with inspection light, and the intensity of the stray light is superposed on the output light as a noise. By taking the difference between the signal intensity with the light source on and the signal intensity with the light source off, however, the effects of the stray light can be eliminated, and a light source of small output can be used. As a result, the inspection high in accuracy can be conducted also by a portable inspection apparatus.

Consequently, the heat generation of the light source is reduced for a lower temperature change of the light source, and the quality change of the beam output from the light source is reduced for higher inspection accuracy.

### Second Embodiment

The inspection apparatus according to the present embodiment is equivalent to the inspection apparatus according to the first embodiment so operated that the inspection light radiated from the light source is passed through a diffusion sheet before being radiated on the sensor chip and by thus changing the characteristics of the inspection light, i.e. by reducing the coherency thereof, the liability of the inspection light to be affected by heat is relaxed, so that even in the case where the quality of the beam output from the light source undergoes a change, the particular change can be relaxed before the light enters the chip.

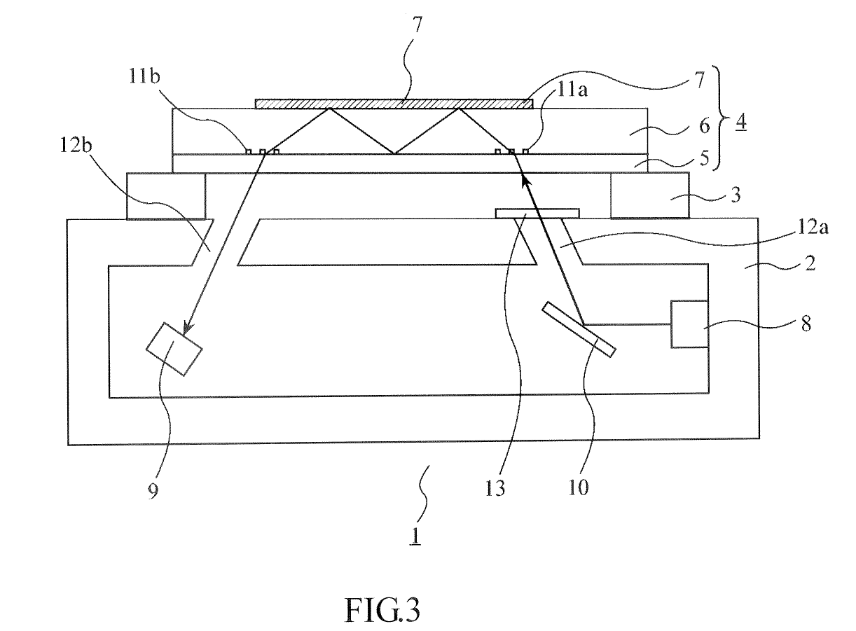

The inspection apparatus according to the present embodiment is shown in the schematic sectional view of FIG. 3. In FIG. 3, the component elements equivalent to those of the inspection apparatus shown in FIG. 1 are designated by the same reference numerals, respectively, and not described in detail.

As shown in FIG. 3, in the inspection apparatus according to the present embodiment, the inspection light radiated from the light source 8 is reflected on the optical system 10, and through the hole 12a formed in the housing 2, radiated on a sensor chip 4. The characteristics of the inspection light are changed by arranging a diffusion sheet 13 in contact with the hole 12a.

The diffusion sheet 13 has the function of reducing the coherency of the inspection light by the following four effects and thus relaxes the effect of the external temperature of the inspection apparatus on the inspection light: (1) The beam pattern is blurred; (2) The beam spread is increased; (3) The polarization is randomized; and (4) The spatial coherency is reduced.

According to the present embodiment, even in the case where the quality of the beam output from the light source 8 is changed by the external temperature, the four effects described above reduces the effect on the measurement signal. The backlight diffusion sheet generally used with liquid crystal can be used also as the diffusion sheet according to the present embodiment. The optimum value of haze, which is an index of optical diffusion, of the diffusion sheet used in the present embodiment, depending on the type of the sensor chip, is preferably in the range of about 30 to 50%.

The haze lower than this range cannot be expected to improve the effects of using the diffusion sheet and therefore is not preferable. The haze higher than the aforementioned range, on the other hand, reduces the amount of the inspection light reaching the sensor chip and hence adversely affects the inspection accuracy.

As explained above, the diffusion sheet is intended to reduce the coherency of the inspection light and thereby to avoid the effect of the temperature change on the inspection environment. At the same time, the diffusion sheet 13 shuts off the heat radiated from the light source 8 and prevents the heat from reaching the sensor chip. This further prevents the sensor chip temperature from increasing.

### Third Embodiment

According to the present embodiment, the heat generated by the turning on of the light source is prevented from reaching the sensor chip, and the light source is fixed on the housing through a mechanical part of a material (heat insulating material) having the heat conductivity of 1.0 W/mK or less.

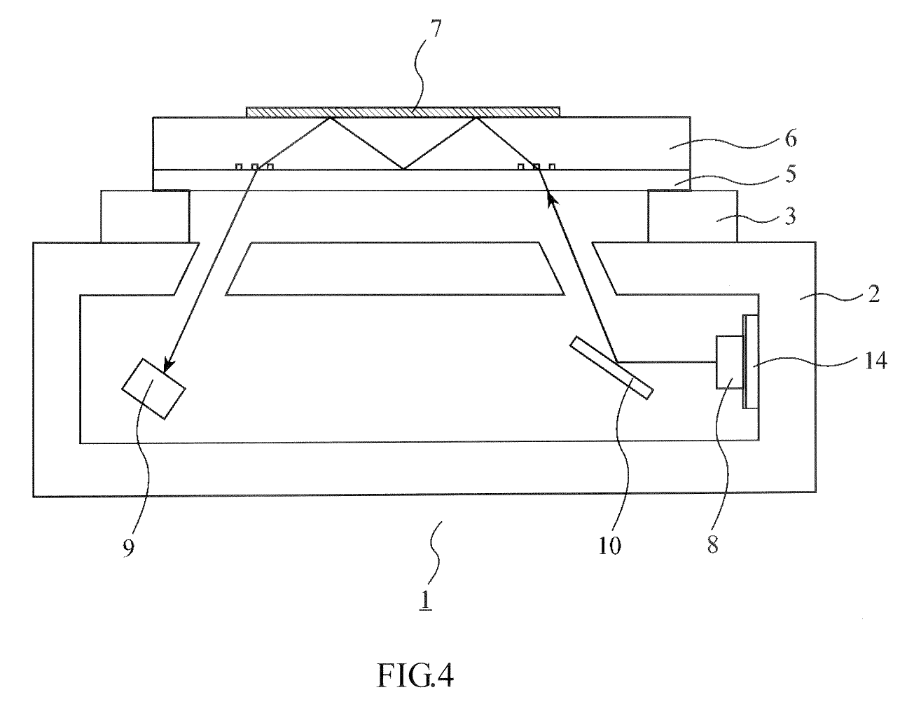

The inspection apparatus according to the present embodiment is schematically shown in FIG. 4. In FIG. 4, the component members equivalent to those of FIG. 1 are designated by the same reference numerals, respectively, and not described in detail.

In the inspection apparatus according to the present embodiment, as shown in FIG. 4, the light source 8 is fixed on the housing 8 using a fixing member 14 formed of a heat insulating material. Even in the case where the external temperature of the optical inspection apparatus undergoes a change, therefore, the heat is shut off by the heat insulative fixing member 14, and the temperature of the light source 8 is not affected. Thus, the beam quality change of the laser diode is minimized and high measurement accuracy maintained.

Various polymer resins can be employed as the heat insulating material as long as the heat conductivity thereof is in the aforementioned range. Especially, PEEK (polyether ether ketone resin) having the heat conductivity of about 0.2 W/mK is preferably used.

### Other Embodiments

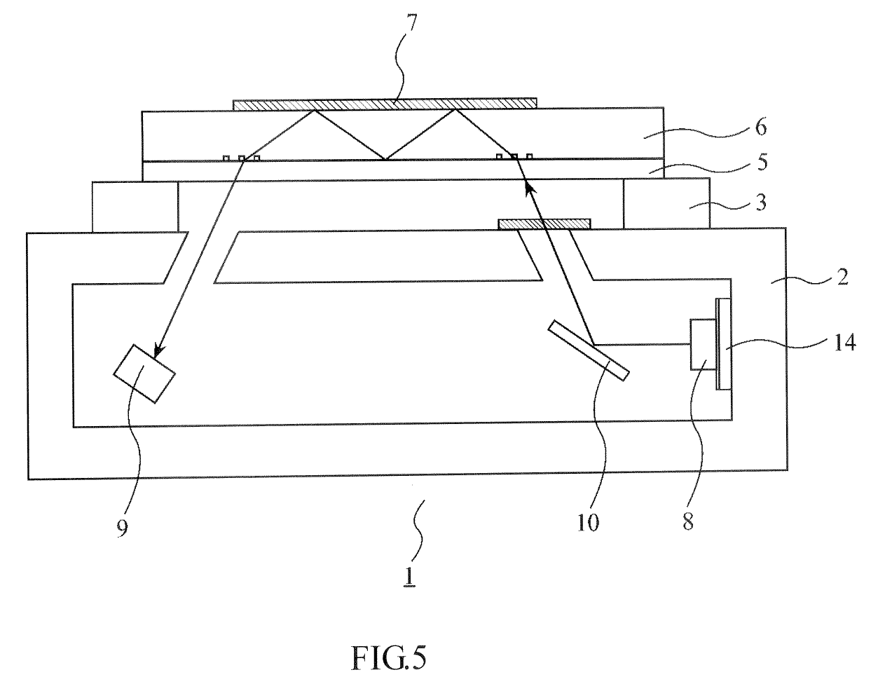

The embodiments described represent examples of means for achieving the object of the present invention. By combining the configurations of these embodiments, a further improved inspection apparatus can be implemented. Specifically, the most preferable result is obtained by the optical inspection apparatus with the light source turned on/off, as shown in FIG. 5, in which the light diffusion sheet 13 is arranged midway on the light path from the light source 8 to the sensor chip 4 and the light source 8 is fixed on the housing 2 through the heat insulating member 14.

The foregoing description mainly refers to the inspection apparatus utilizing the principle of plasmon resonance and absorption. Nevertheless, the present invention is also applicable with equal effect to the technique of measuring the fluorescent light emitted by absorption and excitation of the evanescent wave generated from the inspection light.

Each component element can be modified unless such modifications impair the principle of the present invention.

What is claimed is:

1. An optical inspection method using an optical inspection apparatus comprising a sensor chip including a substrate, an optical waveguide layer arranged on the substrate and a sensing thin film attached on the surface of the optical waveguide layer, a light source for radiating the light on the sensor chip and a photodetector for receiving and converting the light output from the sensor chip into an electrical signal, comprising:
radiating the light on the sensor chip by turning on and off the light source a plurality of time,
receiving and converting the light output from the sensor chip into an electrical signal, and
determining the amount of a substance contained in a specimen placed on the sensing thin film by the electrical signal converted by the photodetector.

2. An optical inspection method according to claim 1,
wherein the amount of a substance is measured from the difference in the light amount measured by the photodetector between the turn-on time period and the turn-off time period of the light source.

3. An optical inspection method according to claim 1,
wherein the light source is either a semiconductor laser device (LD) or an optical semiconductor device (LED).

4. An optical inspection apparatus comprising a sensor chip including a substrate, an optical waveguide layer arranged on the substrate and a sensing thin film attached on the surface of the optical waveguide layer, a light source for radiating the light on the sensor chip and a photodetector for receiving and converting the light output from the sensor chip into an electrical signal,
wherein the light is radiated on the sensor chip for a predetermined length of time and the amount of a substance contained in a specimen placed on the sensing thin film is measured by the optical signal obtained from the sensor chip, and
wherein a diffusion sheet having the haze, as converted into a light diffusion index, of 10.0% or more is arranged on the light path from the light source to the sensor chip.

5. An optical inspection apparatus comprising a light source for radiating the light on a sensor chip including a substrate, an optical waveguide layer arranged on the substrate and a sensing thin film attached on the surface of the optical waveguide layer and a photodetector for receiving and converting the light output from the sensor chip into an electrical signal,
wherein the light is radiated on the sensor chip for a predetermined length of time and the amount of a substance contained in a specimen placed on the sensing thin film is measured by the optical signal obtained from the sensor chip, and
the optical inspection apparatus further comprising a housing for accommodating the light source and the photodetector, the light source being fixed on the housing through a member of a material having the heat conductivity of 1.0 W/mK or less.

6. An optical inspection apparatus comprising a housing on which a sensor chip including a substrate, an optical waveguide layer arranged on the substrate and a sensing thin film attached on the surface of the optical waveguide layer is mounted, a light source accommodated in the housing for radiating the light on the sensor chip and a photodetector arranged in the housing for receiving and converting the light output from the sensor chip into an electrical signal,
wherein the light is radiated on the sensor chip for a predetermined length of time and the amount of a substance contained in a specimen placed on the sensing thin film is measured by the optical signal obtained from the sensor chip,
wherein the light source is fixed on the housing through a member of a material having the heat conductivity of 1.0 W/mK or less,
wherein a diffusion sheet having the haze, as converted into a light diffusion index, of 10.0% or more is arranged on the light path from the light source to the sensor chip, and
wherein the light source is turned on and off for a predetermined length of time during which the light is radiated to measure the amount of a substance in the specimen arranged on the surface of the sensing thin film.
